(19) United States
(12) Patent Application Publication
(10) Pub. No.: US 2013/0326351 A1
(43) Pub. Date: Dec. 5, 2013

(54) Video Post-Processing on Platforms without an Interface to Handle the Video Post-Processing Request from a Video Player

(71) Applicants: Zhiwei Ying, Shanghai (CN); Changliang Wang, Bellevue, WA (US); Chao Cao, Shanghai (CN)

(72) Inventors: Zhiwei Ying, Shanghai (CN); Changliang Wang, Bellevue, WA (US); Chao Cao, Shanghai (CN)

(21) Appl. No.: 13/899,970

(22) Filed: May 22, 2013

(30) Foreign Application Priority Data
May 31, 2012 (US) PCT/US2012/040326

(51) Int. Cl. G06F 3/0484

(52) U.S. Cl. CPC G06F 3/0484
USPC 715/719

(57) ABSTRACT

In order to use video post-processing capabilities available in some graphics and central processing unit hardware available now and in the future, some platforms like the Android platform need to be adapted. A user may select a video post-processing function using a graphical user interface. The selection is communicated to an operating system that does not enable video post-processing, using an inter procedure communication.

### Cross-Reference to Related Application

This application claims priority to PCT/US2012/040326 filed May 31, 2012.

This relates to video processing.

The Android platform allows open source operating systems and is designed for smartphones and tablet computers. Android uses a media service framework called libstagefright. Libstagefright does not provide an interface for video post-processing. Changing the libstagefright interface on Android platforms is inconvenient because it would be necessary to modify all video players on Android markets to use video post-processing capabilities.

Thus even if a central processing unit/graphics processing unit hardware were provided with elaborate video post-processing capabilities, the Android platform is not readily adaptable to those capabilities.

### BRIEF DESCRIPTION OF THE DRAWINGS

Some embodiments are described with respect to the following figures:

FIG. 1 is a software depiction of an Android platform in accordance with one embodiment;

FIG. 2 is a depiction of the user layer and kernel layer in an Android platform in accordance with one embodiment;

FIG. 3 is a depiction of a sequence for enabling an Android platform to use hardware based post-processing capabilities according to one embodiment;

FIG. 4 is a depiction of a block diagram for a processor-based system according to one embodiment; and

FIG. 5 is front elevational view of the platform shown in FIG. 4.

### DETAILED DESCRIPTION

In order to use video post-processing capabilities available in some graphics and central processing unit hardware available now and in the future, some platforms like the Android platform need to be adapted. This is because the libstagefright media service framework on Android platforms is not adapted to the use of video post-processing. Generally all the video players that work on Android work with libstagefright and simply modifying libstagefright is not viable at least for third party hardware suppliers.

For example some graphics processors may provide post-processing features not now available in Android including scaling, color space conversion, Hue, Separation Bias and Contrast (HSBC), ColorFill, sharpness, and de-noise, de-interlace, to mention some examples. However, the present invention is not limited to Android platforms but instead may be generally applicable to any platform that is not adapted to use video post-processing.

Video processing (VP) Panel is a Java application that runs on Android. The graphical user interface (GUI) part of the VP Panel is developed in Eclipse which is the default application development environment for Android applications. VP Panel communicates with graphics drivers used by graphics processing chips including Intel® graphics processing units. Particularly, the graphics binder called IBinder may be used on some graphics processing chips available from Intel. IBinder is a fast, light-weight inter procedure communication mechanism on Android.

On VP Panel, a user can set different video processing features by scrolling left to right on different VP feature bars. The VP Panel then notifies the driver of the selected video processing feature via the inter procedure communication (IPC) immediately. This notification mechanism may be implemented in a native C library and a Java Native Interface (JNI) interface is provided for Java applications to communicate with.

The new interface for the graphics drivers on Android starts the IBinder service when the driver initializes. The service always waits for the notification from VP Panel. When it receives that notification, the service changes the VP parameters to the instruction to the VP Panel before rendering the image by the hardware according to the user's setting in the VP Panel.

On Windows operating systems, the graphics drivers use the Windows registry to store the user configurations and the registry notification mechanism to send the user input to the driver. But on Linux there is neither registry implementation or registry notification mechanisms. Thus a similar registry mechanism may be created on Android, for example, by using a text file to simulate all the registry functionality and to use IBinder to notify the driver as the notification mechanism. In one embodiment, the user's settings in VP Panel are kept in a text file on the Android platform. This registry text file and Android simulates the registry mechanism used on Windows systems. It provides key, value, and data storage for application configuration. It also provides notification mechanism for registry changes.

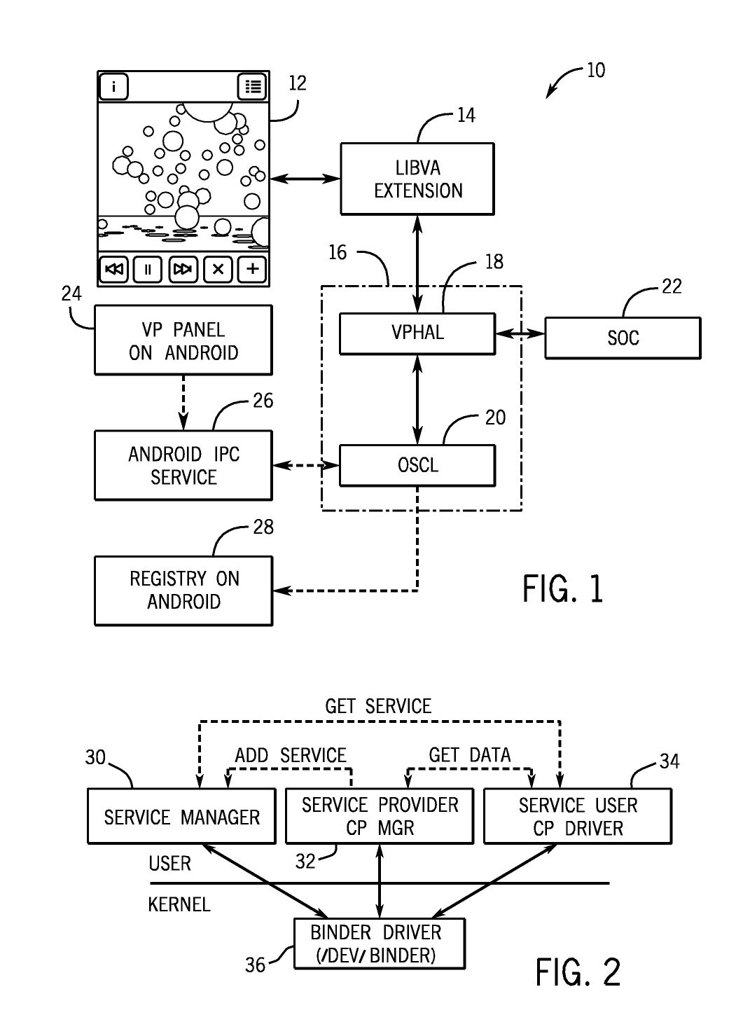

FIG. 1 illustrates one embodiment using VP Panel to provide video processing capabilities to Android platforms. The Libya extension 14 is a device driver interface for graphics drivers on Linux and Android. VPHAL 18 is a video post-processing hardware extraction layer. It communicates with a processor such as the system on a chip (SOC) 22. OSCL 20 is an operating system common layer. VP Panel talks to the graphics driver via an inter procedure communication service 26 on Android to control the video post-processing effects when playing video. The use of the service 26 enables VP Panel to interact with the Android platform.

IBinder is the fast and lightweight inter procedure communication mechanism on Android. As shown in FIG. 2, a service provider 32 adds a service (addService) into a service manager 30. A service user 34 can get information (getService) from the service manager. Then the service user can talk to the service provider. The service user can talk to the service provider via a getData interface.

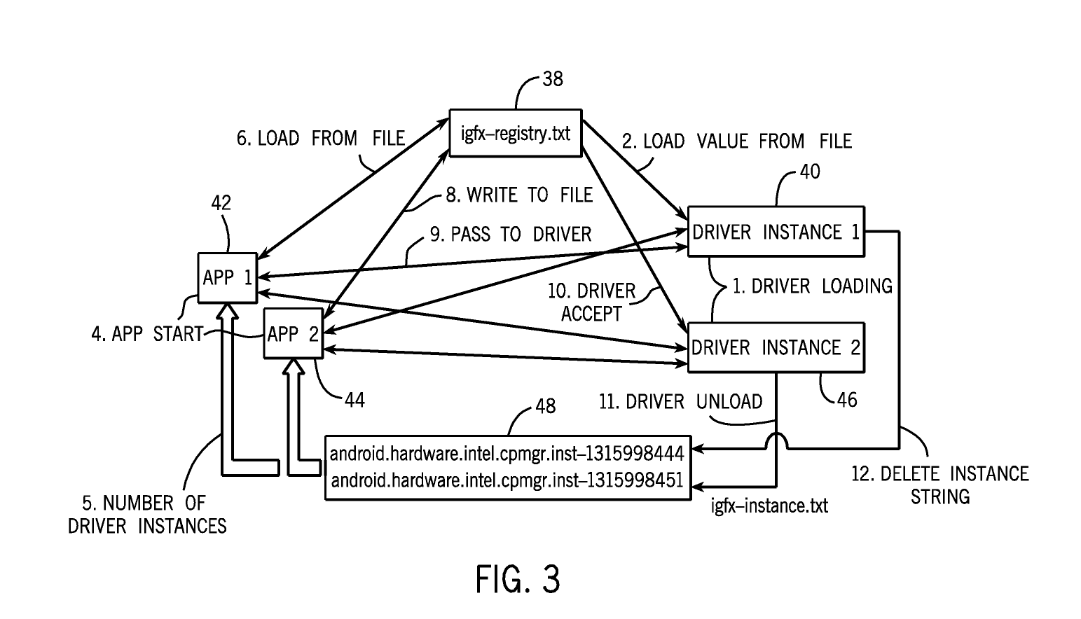

IBinder is fast and lightweight but it lacks support for multiple instances 40, 46 of the application as shown in FIG. 3. Its functionality may be expanded to support multi-instant driver communications with an application/common user interface as shown in FIG. 3. This provides a graphical user interface to control video processing features. Each driver instance initiates its own IBinder service which is unique in the system. When there are multiple driver instances in system memory, there will be the same number of IBinder services in the system. Information is stored in a shared file. The application can read the IBinder service information from a share file 48 and establish a connection to all drivers.

Thus referring to FIG. 3, a way to expand the functionality of IBinder to support multi instances of driver communications to support multiple video streams is illustrated. The block 48 creates an identifier associated with Intel brand processors. However, a different identifier may be used in connection with other processor manufacturers. In this situation, two applications 42 and 44 each have instances 40 and 46 of the drivers. But more applications and more streams of video or audio data may be implicated. The text file 38 for the graphics processor registry function communicates with the applications and the drivers.

Thus the flow begins with loading of the drivers 40 and/or 46 as indicated at 1. Then a value is loaded from the text file 38 as indicated at 2. Next the applications 42 and/or 44 start as indicated at 4. The applications learn how many driver instances there are from the hardware identifiers at 48 as indicated at 5. The registry information is then loaded from the text file 38 as indicated at 6. Then at 8, the information on the number of streams is written to the file 38. At 9 the applications pass information to the drivers 40 and 46 and at 10 the drivers accept this information. After the process is complete, the drivers are unloaded at 11 and the instance strings are deleted at 12.

These same techniques can be applied in general to the Linux environment. The only difference between Linux and Android is that a semaphore is used on Linux instead of using IBinder as done in Android. That is the functions of VP Panel and the multi procedure communication service may both be accomplished via the semaphore.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

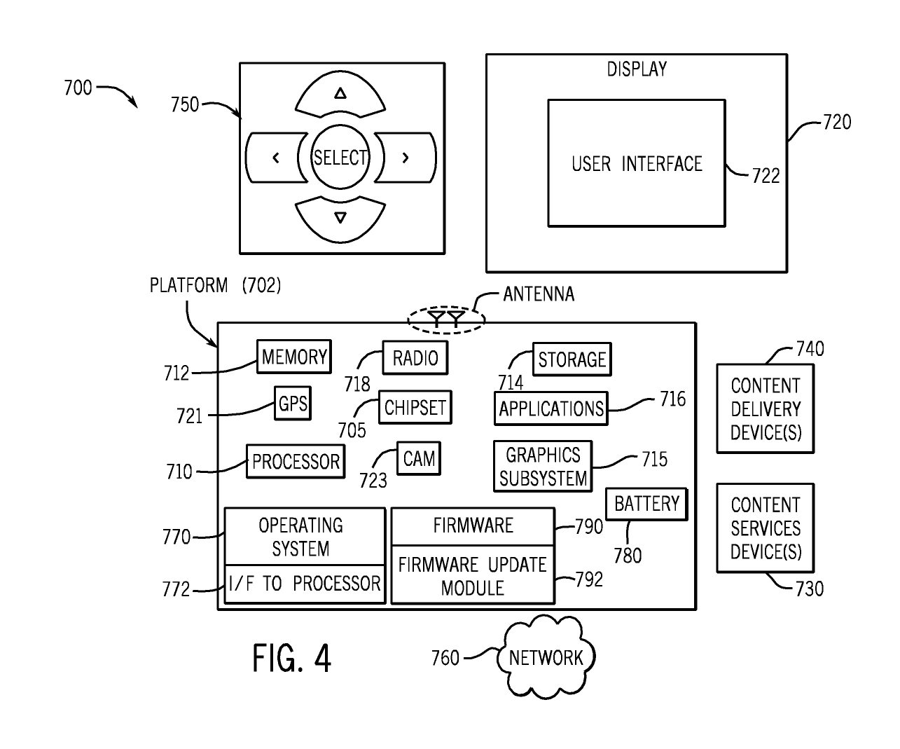

The sequences shown in FIGS. 3 and 4 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

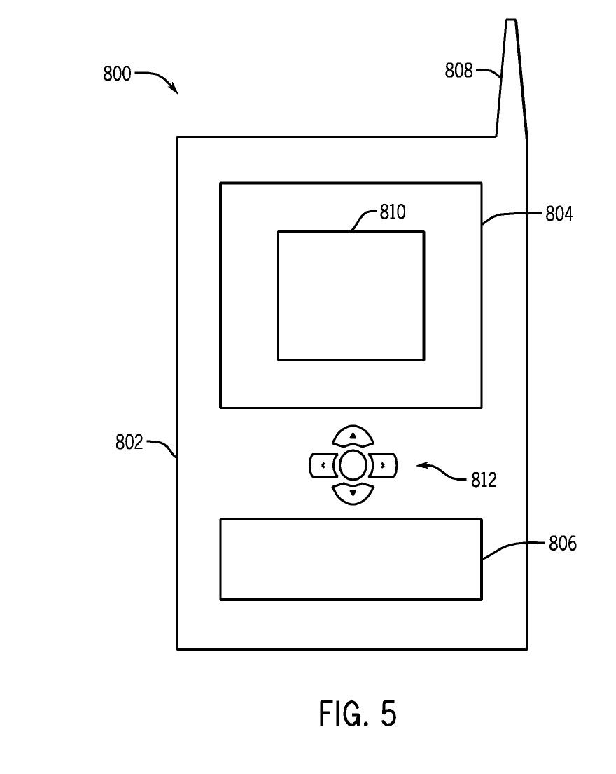

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 5, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

A method may include enabling a user to select a video post-processing function using a graphical user interface and communicating the selection, to an operating system that does not enable video post-processing, using an inter procedure communication. The method may also include enabling video post-processing on an Android operating system, and emulating a registry mechanism on an operating system without a registry mechanism. The method may include implementing said registry mechanism using a text file as a notification mechanism. In one embodiment the method includes supporting multi-instant driver communication with an application, obtaining a processor identifier, and enabling two applications to determine how many driver instances exist using hardware identifiers. In another embodiment a semaphore is used as an inter procedure communication on a Linux operating system.

At least one machine readable medium may comprise a plurality of instructions and, in response to being executed on a computing device, causing the computing device to carry out a method according to any one of steps described above.

An apparatus may include a processor to enable a user to select a video post-processing function using a graphical user interface and to communicate the selection to an operating system that does not enable video post-processing, using an inter procedure communication and an emulated registry mechanism. The apparatus may include an operating system, a battery, and firmware and a module to update said firmware. The apparatus operating system may be an Android operating system. A registry mechanism may use a text file as a notification mechanism. The processor may support multi-instance driver communication with an application and may obtain a processor identifier. The processor may enable two applications to determine how many driver instances exist using hardware identifiers. The operating system may also be a Linux operating system. Then the processor uses semaphore as the inter procedure communication.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:

One example embodiment may be a method enabling a user to select a video post-processing function using a graphical user interface; and communicating the selection, to an operating system that does not enable video post-processing, using an inter procedure communication. The method may also include enabling video post-processing on an Android operating system. The method may also include emulating a registry mechanism on an operating system without a registry mechanism. The method may also include supporting multi-instant driver communication with an application. The method may also include obtaining a processor identifier. The method may also include enabling two applications to determine how many driver instances exist using hardware identifiers. The method may also include using a semaphore as an inter procedure communication on a Linux operating system.

One example embodiment may be a machine readable medium comprising a plurality of instructions and, in response to being executed on a computing device, causing the computing device to carry out a method.

Another example embodiment may be an apparatus comprising a processor to enable a user to select a video post-processing function using a graphical user interface and to communicate the selection to an operating system that does not enable video post-processing, using an inter procedure communication; and an emulated registry mechanism. One example embodiment may be an apparatus including an operating system, and a battery. An apparatus may include firmware and a module to update said firmware. An apparatus may include said operating system. An apparatus may include said operating system is an Android system. An apparatus may include said registry mechanism to use a text as a notification mechanism. An apparatus may include said processor to support multi-instance driver communication with an application. An apparatus may include said processor to obtain a processor notifier. An apparatus may include said processor to enable two applications to determine how many driver instances exist using hardware identifiers. An apparatus may include said operating system is a Linux operating system. An apparatus may include said processor to use semaphore as the inter procedure communication.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a user to select a video post-processing function using a graphical user interface; and
communicating the selection, to an operating system that does not enable video post-processing, using an inter procedure communication.

2. The method of claim 1 including enabling video post-processing on an Android operating system.

3. The method of claim 1 including emulating a registry mechanism on an operating system without a registry mechanism.

4. The method of claim 3 including implementing said registry mechanism using a text file as a notification mechanism.

5. The method of claim 1 including supporting multi-instant driver communication with an application.

6. The method of claim 5 including obtaining a processor identifier.

7. The method of claim 6 including enabling two applications to determine how many driver instances exist using hardware identifiers.

8. The method of claim 1 including using a semaphore as an inter procedure communication on a Linux operating system.

9. At least one non-transitory machine readable medium comprising a plurality of instructions and, in response to being executed on a computing device, causing the computing device to carry out a sequence comprising:
enabling a user to select a video post-processing function using a graphical user interface; and
communicating the selection, to an operating system that does not enable video post-processing, using an inter procedure communication.

10. The medium of claim 9, said sequence including enabling video post-processing on an Android operating system.

11. The medium of claim 9, said sequence including emulating a registry mechanism on an operating system without a registry mechanism.

12. The medium of claim 11, said sequence including implementing said registry mechanism using a text file as a notification mechanism.

13. The medium of claim 9, said sequence including supporting multi-instant driver communication with an application.

14. The medium of claim 13, said sequence including obtaining a processor identifier.

15. The medium of claim 14, said sequence including enabling two applications to determine how many driver instances exist using hardware identifiers.

16. The medium of claim 9, said sequence including using a semaphore as an inter procedure communication on a Linux operating system.

17. An apparatus comprising:
a processor to enable a user to select a video post-processing function using a graphical user interface and to communicate the selection to an operating system that does not enable video post-processing, using an inter procedure communication; and
an emulated registry mechanism.

18. The apparatus of claim 17 including an operating system.

19. The apparatus of claim 17 including a battery.

20. The apparatus of claim 17 including firmware and a module to update said firmware.

21. The apparatus of claim 18 wherein said operating system is an Android operating system.

22. The apparatus of claim 17 wherein said registry mechanism to use a text file as a notification mechanism.

23. The apparatus of claim 17 wherein said processor to support multi-instance driver communication with an application.

24. The apparatus of claim 23 wherein said processor to obtain a processor identifier.

25. The apparatus of claim 24 said processor to enable two applications to determine how many driver instances exist using hardware identifiers.

26. The apparatus of claim 18 wherein said operating system is a Linux operating system.

27. The apparatus of claim 26 said processor to use semaphore as the inter procedure communication.
